(19) United States
(12) Patent Application Publication
(10) Pub. No.: US 2011/0065624 A1
(43) Pub. Date: Mar. 17, 2011

(54) FLUID LAUNDRY DETERGENT COMPOSITION

(76) Inventors: Jean-Pol BOUTIQUE, Gembloux (BE); Frederik Vandenberghe, Gentbrugge (BE)

(21) Appl. No.: 12/877,302

(22) Filed: Sep. 8, 2010

(30) Foreign Application Priority Data
Sep. 14, 2009 (EP) 09170171.4

(51) Int. Cl. C11D 17/00

(52) U.S. Cl. 510/296; 510/337

(57) ABSTRACT

Compact fluid laundry compositions comprising polymer deposition aids and multivalent water-soluble builders and/or chelants can be stabilized using external structurant systems.

Such compact fluid laundry compositions may be packaged in unit-dose form. These compact fluid laundry compositions are ideally suited for treating laundry substrates.

### FIELD OF THE INVENTION

The present invention relates to phase stable, easy to pour, structured compact fluid laundry compositions that are capable of delivering good cleaning, stain-removal and softness performance. The invention also relates to methods for treating fabrics with such structured compact fluid laundry compositions.

### BACKGROUND OF THE INVENTION

Fluid laundry products, such as liquids and gels are preferred by many consumers over solid detergent forms. Many consumers also seek to conserve resources and eliminate waste without wishing to sacrifice the performance of their laundry detergent product. Moreover in certain countries, disposing of bulky waste packaging, e.g., plastic containers, requires troublesome recycling steps such as waste sorting, and is costly to the consumer.

While there is high interest in concentrated or so-called compact laundry products, compaction of fluid laundry detergents is technically challenging. At high compaction levels, the concentration of polymer deposition aids needed for stain removal and softness performance can induce phase separation. Also, compacting the detergent composition ideally means increasing the concentration of multivalent water-soluble builders and chelants required for good cleaning. However, it is extremely challenging to prevent high levels of builders and chelants from salting out the less soluble polymer deposition aids. One approach to stabilize polymer deposition aids is through the intrinsic structuring properties of highly concentrated surfactants and the use of non-aminofunctional solvents. However, this approach may waste surfactant, increase cost, and can limit formulation flexibility. An additional problem is that the composition becomes increasingly stringy and difficult to pour as the concentration of the polymer deposition aid increases.

Consequently, the need remains for a stable concentrated or compact fluid laundry detergent comprising polymer deposition aid, without the need for excess surfactants or solvents to stabilize the composition and without limiting formulation flexibility. Ideally such concentrated or compact fluid laundry detergent should be presented in a fashion that is easy to use, with a pour profile that suits consumers.

### SUMMARY OF THE INVENTION

According to the present invention, there is provided a fluid laundry detergent composition comprising: an anionic surfactant, a polymer deposition aid, an external structuring system, from 0.6% to 10% by weight of the fluid laundry detergent composition of a multivalent water-soluble organic builder and/or chelants, and from 1% to 45% by weight of water.

### DETAILED DESCRIPTION OF THE INVENTION

The present invention solves the technical problem of stabilizing compact fluid laundry detergents comprising levels of polymer deposition aids that, in the presence of high levels of multivalent water-soluble builders and/or chelants, would normally induce phase-splitting. The added benefit from the external structuring system of reducing the stringiness of such compositions during dispensing from a bottle is also entirely unexpected.

### Definitions

As used herein, “fluid laundry detergent composition” refers to any laundry treatment composition comprising a fluid capable of wetting and cleaning fabric e.g., clothing, in a domestic washing machine. The composition can include solids or gases in suitably subdivided form, but the overall composition excludes product forms which are nonfluid overall, such as tablets or granules. The compact fluid detergent compositions preferably have densities in the range from 0.9 to 1.3 grams per cubic centimeter, more specifically from 1.00 to 1.10 grams per cubic centimeter, excluding any solid additives but including any bubbles, if present.

As used herein, the term “external structuring system” refers to a selected compound or mixture of compounds which provide either a sufficient yield stress or low shear viscosity to stabilize the fluid laundry detergent composition independently from, or extrinsic from, any structuring effect of the detersive surfactants of the composition. By “internal structuring” it is meant that the detergent surfactants, which form a major class of laundering ingredients, are relied on for providing the necessary yield stress or low shear viscosity.

All percentages, ratios and proportions used herein are by weight percent of the composition, unless otherwise specified. All average values are calculated “by weight” of the composition or components thereof, unless otherwise expressly indicated.

Fluid laundry detergent compositions of the present invention comprise: an anionic surfactant; a polymer deposition aid; an external structuring system; multivalent water-soluble organic builder and/or chelants; and water. Preferably, they also comprise anionic nonsoap surfactants, especially including an alkyl(polyalkoxy)sulfate; other surfactants, especially nonionic surfactants; organic, non-aminofunctional solvents and laundering adjuncts selected from the group consisting of: enzymes, enzyme stabilizers, optical brighteners, particulate material such as clays and encapsulated sensitive materials, hydrotropes, perfume and other odour control agents, soil suspending polymers and/or soil release polymers, suds suppressors, silicones, pH adjusting agents, dye transfer inhibiting agents, preservatives, non-fabric substantive dyes and mixtures thereof.

### Anionic Surfactant:

The fluid laundry detergent compositions of the present invention comprise one or more anionic surfactants. By nature, every anionic surfactant known in the art of detergent compositions may be used, such as disclosed in “Surfactant Science Series”, Vol. 7, edited by W. M. Linfield, Marcel Dekker. However, the compositions of the present invention comprise preferably at least a sulphonic acid surfactant, such as a linear alkyl benzene sulphonic acid, but water-soluble salt forms may also be used. Anionic surfactant(s) are typically present at a level of from 1.0% to 70%, preferably from 5.0% to 50% by weight, and more preferably from 10% to 30% by weight of the fabric treatment composition.

Anionic sulfonate or sulfonic acid surfactants suitable for use herein include the acid and salt forms of linear or branched C5-C20, more preferably C10-C16, more preferably C11-C13 alkylbenzene sulfonates, C5-C20 alkyl ester sulfonates, C6-C22 primary or secondary alkane sulfonates, C5-C20 sulfonated polycarboxylic acids, and any mixtures thereof, but preferably C11-C13 alkylbenzene sulfonates. The aforementioned surfactants can vary widely in their 2-phenyl isomer content.

Anionic sulphate salts suitable for use in the compositions of the invention include the primary and secondary alkyl sulphates, having a linear or branched alkyl or alkenyl moiety having from 9 to 22 carbon atoms or more preferably 12 to 18 carbon atoms.

Also useful are beta-branched alkyl sulphate surfactants or mixtures of commercial available materials, having a weight average (of the surfactant or the mixture) branching degree of at least 50%.

Mid-chain branched alkyl sulphates or sulfonates are also suitable anionic surfactants for use in the compositions of the invention. Preferred are the C5-C22, preferably C10-C20 mid-chain branched alkyl primary sulphates. When mixtures are used, a suitable average total number of carbon atoms for the alkyl moieties is preferably within the range of from greater than 14.5 to 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used.

Other suitable anionic surfactants for use herein include fatty methyl ester sulphonates and/or alkyl ethyoxy sulphates (AES) and/or alkyl polyalkoxylated carboxylates (AEC). Mixtures of anionic surfactants can be used, for example mixtures of alkylbenzenesulphonates and AES.

The anionic surfactants are typically present in the form of their salts with alkanolamines or alkali metals such as sodium and potassium. Preferably, the anionic surfactants are neutralized with alkanolamines such as Monoethanolamine or Triethanolamine, and are fully soluble in the liquid phase.

### Polymer Deposition Aid:

Preferably, the fluid laundry detergent composition comprises from 0.1% to 7%, more preferably from 0.2% to 3%, of the polymer deposition aid. As used herein, “polymer deposition aid” refers to any cationic polymer or combination of cationic polymers that significantly enhance deposition of a fabric care benefit agent onto the fabric during laundering. Suitable polymer deposition aids can comprise a cationic polysaccharide and/or a copolymer. “Fabric care benefit agent” as used herein refers to any material that can provide fabric care benefits. Non-limiting examples of fabric care benefits include, but are not limited to: fabric softening, color protection, color restoration, pill/fuzz reduction, anti-abrasion and anti-wrinkling. Non-limiting examples of fabric care benefit agents include: silicone derivatives, oily sugar derivatives, dispersible polyolefins, polymer latexes, cationic surfactants and combinations thereof.

An effective deposition aid preferably has a strong binding capability with the water insoluble fabric care benefit agents via physical forces such as van der Waals forces or non-covalent chemical bonds such as hydrogen bonding and/or ionic bonding. It preferably has a very strong affinity to natural textile fibers, particularly cotton fibers.

The deposition aid must be water soluble and have a flexible molecular structure so that it can cover the water insoluble fabric care benefit agent particle surface or hold several particles together. Therefore, the deposition aid is preferably not cross-linked and preferably does not have a network structure as these both tend to lack molecular flexibility.

In order to drive the fabric care benefit agent onto the fabric, the net charge of the deposition aid is preferably positive in order to overcome the repulsion between the fabric care benefit agent and the fabric since most fabrics are comprised of textile fibers that have a slightly negative charge in aqueous environments. Examples of fibers exhibiting a slightly negative charge in water include but are not limited to cotton, rayon, silk, wool, etc.

Preferably, the deposition aid is a cationic or amphoteric polymer. The amphoteric polymers of the present invention preferably have a net cationic charge, i.e., the total cationic charge on these polymers preferably exceeds the total anionic charge. The cationic charge density of the polymer ranges from 0.05 milliequivalents/g to 6 milliequivalents/g. The charge density is calculated by dividing the number of net charge per repeating unit by the molecular weight of the repeating unit. In one embodiment, the charge density varies from 0.1 milliequivalents/g to 3 milliequivalents/g. The positive charges could be on the backbone of the polymers or the side chains of polymers.

Preferred examples of the polymer deposition aid of the present invention include:

### I. Cationic Polysaccharides

Cationic polysaccharides include but are not limited to cationic cellulose derivatives, cationic guar gum derivatives, chitosan and derivatives and cationic starches. Cationic polysacchrides have a molecular weight from 50,000 to 2 million, preferably from 100,000 to 1,000,000. Most preferably, cationic cellulose have a molecular weight from 200,000 to 800,000 and cationic guars from 500,000 to 1.5 million.

One group of preferred cationic polysaccharides are cationic cellulose derivatives, preferably cationic cellulose ethers. These cationic materials have repeating substituted anhydroglucose units that correspond to the general Structural Formula I as follows:

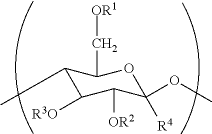

### Structural Formula I

Wherein R¹, R², R³ are each independently H, CH₃, C₈₋₂₄ alkyl (linear or branched),

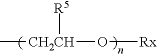

or mixtures thereof; wherein n is from 1 to 10; Rx is H, CH₃, C₈₋₂₄ alkyl (linear or branched),

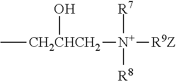

or mixtures thereof, wherein Z is a water soluble anion, preferably a chlorine ion and/or a bromine ion; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and
R⁸ and R⁹ are each independently CH₃, CH₂CH₃, phenyl, or mixtures thereof:

### R⁴ is H,

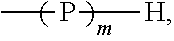

or mixtures thereof wherein P is a repeat unit of an addition polymer formed by radical polymerization of a cationic monomer such as

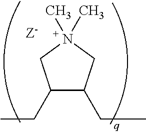

wherein Z′ is a water-soluble anion, preferably chlorine ion, bromine ion or mixtures thereof and q is from 1 to 10.

Alkyl substitution on the anhydroglucose rings of the polymer ranges from 0.01% to 5% per glucose unit, more preferably from 0.05% to 2% per glucose unit, of the polymeric material.

The cationic cellulose ethers of Structural Formula I likewise include those which are commercially available and further include materials which can be prepared by conventional chemical modification of commercially available materials. Commercially available cellulose ethers of the Structural Formula I type include the JR 30M, JR 400, JR 125, LR 400 and LK 400 polymers, all of which are marketed byAmerchol Corporation, Edgewater N.J. and Celquat H200 and Celquat L-200 available from National Starch and Chemical Company or Bridgewater, N.J.

Cationic starches useful in the present invention are described by D. B. Solarek in Modified Starches, Properties and Uses published by CRC Press (1986). Cationic starches are commercially available from National Starch and Chemical Company under the Trade Name Cato.

The cationic guar derivatives suitable in the present invention are illustrated by:

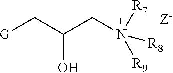

Where G is the galactomannan backbone, R₇ is CH₃, CH₂CH₃, a phenyl group, a C₈₋₂₄ alkyl group (linear or branched), or mixture thereof; and R₈ and R₉ are each independently CH₃, CH₂CH₃, phenyl, or mixtures thereof, Z⁻ is a suitable anion. Preferred guar derivatives are guar hydroxypropyltrimethyl ammonium chloride. Examples of cationic guar gums are Jaguar C13 and Jaguar Excel available from Rhodia, Inc of Cranburry N.J.

### II. Synthetic Cationic Polymers

Cationic polymers in general and their method of manufacture are known in the literature. For example, a detailed description of cationic polymers can be found in an article by M. Fred Hoover that was published in the Journal of Macromolecular Science-Chemistry, A4(6), pp 1327-1417, October, 1970. Other suitable cationic polymers are those used as retention aids in the manufacture of paper. They are described in “Pulp and Paper, Chemistry and Chemical Technology Volume III edited by James Casey (1981). The Molecular weight of these polymers is in the range of 2000-5 million.

The synthetic cationic polymers of use in the present invention will be better understood when read in light of the Hoover article and the Casey book, the present disclosure and the Examples herein. Synthetic polymers include but are not limited to synthetic addition polymers of the general structure

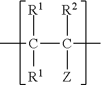

wherein R¹, R², and Z are defined herein below. Preferably, the linear polymer units are formed from linearly polymerizing monomers. Linearly polymerizing monomers are defined herein as monomers which under standard polymerizing conditions result in a linear polymer chain or alternatively which linearly propagate polymerization. In certain embodiments, the linearly polymerizing monomers of use in the present invention have the formula:

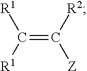

However, those of skill in the art recognize that many useful linear monomer units are introduced indirectly, inter alia, vinyl amine units, vinyl alcohol units, and not by way of linearly polymerizing monomers. For example, vinyl acetate monomers once incorporated into the backbone are hydrolyzed to form vinyl alcohol units. Linear polymer units may be directly introduced, i.e. via linearly polymerizing units, or indirectly, i.e. via a precursor as in the case of vinyl alcohol cited herein above.

Each R¹ is independently hydrogen, C₁-C₄ alkyl, substituted or unsubstituted phenyl, substituted or unsubstituted benzyl, carbocyclic, heterocyclic, and mixtures thereof. Preferably R¹ is hydrogen, C₁-C₄ alkyl, phenyl, and mixtures thereof, more preferably hydrogen and methyl.

Each R² is independently hydrogen, halogen, C₁-C₄ alkyl, C₁-C₄ alkoxy, substituted or unsubstituted phenyl, substituted or unsubstituted benzyl, carbocyclic, heterocyclic, and mixtures thereof. Preferred R² is hydrogen, C₁-C₄ alkyl, and mixtures thereof.

Each Z is independently hydrogen; hydroxyl; halogen; —(CH₂)ₘR, wherein R is hydrogen, hydroxyl, halogen, nitrilo, —OR³, —O(CH₂)ₙN(R³)₂, —O(CH₂)ₙN⁺(R³)₃X⁻, —C(O)O(CH₂)ₙN(R³)₂, —C(O)O(CH₂)ₙN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻, a non-aromatic nitrogen heterocycle comprising a quaternary ammonium ion, a non-aromatic nitrogen heterocycle comprising an N-oxide moiety, an aromatic nitrogen containing heterocyclic wherein one or more or the nitrogen atoms is quaternized; an aromatic nitrogen containing heterocycle wherein at least one nitrogen is an N-oxide; —NHCHO (formamide), or mixtures thereof; wherein each R³ is independently hydrogen, C₁-C₈ alkyl, C₂-C₈ hydroxyalkyl, and mixtures thereof; X is a water soluble anion; the index n is from 1 to 6; carbocyclic, heterocyclic, or mixtures thereof; —(CH₂)ₘCOR′ wherein R′ is −OR³, —O(CH₂)ₙN(R³)₂, —O(CH₂)ₙN⁺(R³)₃X⁻, —NR³(CH₂)ₙN(R³)₂, —NR³(CH₂)ₙN⁺(R³)₃X⁻, —(CH₂)ₙN(R³)₂, —(CH₂)ₙN⁺(R³)₃X⁻, or mixtures thereof, wherein R³, X, and n are the same as defined herein above. A preferred Z is —O(CH₂)ₙN⁺(R³)₃X⁻, wherein the index n is 2 to 4. The index m is from 0 to 6, preferably 0 to 2, more preferably 0.

Non-limiting examples of addition polymerizing monomers comprising a heterocyclic Z unit includes 1-vinyl-2-pyrrolidinone, 1-vinylimidazole, 2-vinyl-1,3-dioxolane, 4-vinyl-1-cyclohexene-1,2-epoxide, and 2-vinylpyridine.

The preferred polymers and co-polymers comprise Z units which have a cationic charge or which result in a unit which forms a cationic charge in situ. When the co-polymers comprise more than one Z unit, for example, Z¹, Z², . . . Zⁿ units, at least 1% of the monomers which comprise the co-polymers will comprise a cationic unit. A non-limiting example of a Z unit which can be made to form a cationic charge in situ is the —NHCHO unit, formamide. The formulator can prepare a polymer or co-polymer comprising formamide units some of which are subsequently hydrolyzed to form vinyl amine equivalents.

The polymers or co-polymers of use in the present invention can comprise one or more cyclic polymer units which are derived from cyclically polymerizing monomers. Cyclically polymerizing monomers are defined herein as monomers which under standard polymerizing conditions result in a cyclic polymer residue as well as serving to linearly propagate polymerization. Preferred cyclically polymerizing monomers of use in the present invention have the formula:

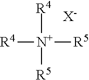

wherein each R⁴ is independently an olefin comprising unit which is capable of propagating polymerization in addition to forming a cyclic residue with an adjacent R⁴ unit; R⁵ is C₁-C₁₂ linear or branched alkyl, benzyl, substituted benzyl, and mixtures thereof; X is a water soluble anion.

Non-limiting examples of R⁴ units include allyl and alkyl substituted allyl units. Preferably the resulting cyclic residue is a six-member ring comprising a quaternary nitrogen atom.

R⁵ is preferably C₁-C₄ alkyl, preferably methyl.

An example of a cyclically polymerizing monomer is dimethyl diallyl ammonium having the formula:

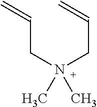

which results in a polymer or co-polymer having units with the formula:

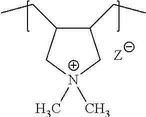

wherein preferably the index z is from 10 to 50,000.

Nonlimiting examples include copolymers wherein the copolymers comprises:
a) a cationic monomer selected from a group consisting N,N-dialkylaminoalkyl methacrylate, N,N-dialkylaminoalkyl acrylate, N,N-dialkylaminoalkyl acrylamide, N,N-dialkylaminoalkylmethacrylamide, their quaternized derivatives, vinylamine and its derivatives, allylamine and its derivatives, vinyl imidazole, quaternized vinyl imidazole and diallyl dialkyl ammonium chloride and mixtures thereof,
b) and a second monomer selected from a group consisting of acrylamide (AM), N,N-dialkyl acrylamide, methacrylamide, N,N-dialkylmethacrylamide, C1-C12 alkyl acrylate, C1-C12 hydroxyalkyl acrylate, C1-C12 hydroxyetheralkyl acrylate, C1-C12 alkyl methacrylate, C1-C12 hydroxyalkyl methacrylate, vinyl acetate, vinyl alcohol, vinyl formamide, vinyl acetamide, vinyl alkyl ether, vinyl butyrate and derivatives and mixtures thereof.

Preferred cationic monomers include N,N-dimethyl aminoethyl acrylate, N,N-dimethyl aminoethyl methacrylate (DMAM), [2-(methacryloylamino)ethyl]tri-methylammonium chloride (QDMAM), N,N-dimethylaminopropyl acrylamide (DMAPA), N,N-dimethylaminopropyl methacrylamide (DMAPMA), acrylamidopropyl trimethyl ammonium chloride, methacrylamidopropyl trimethylammonium chloride (MAPTAC), quaternized vinyl imidazole and diallyldimethylammonium chloride and derivatives thereof.

Preferred second monomers include acrylamide, N,N-dimethyl acrylamide, C1-C4 alkyl acrylate, C1-C4 hydroxyalkylacrylate, vinyl formamide, vinyl acetate, and vinyl alcohol. Most preferred nonionic monomers are acrylamide, hydroxyethyl acrylate (HEA), hydroxypropyl acrylate and derivative thereof, acrylic acid, methacrylic acid, maleic acid, vinyl sulfonic acid, styrene sulfonic acid, acrylamidopropylmethane sulfonic acid (AMPS) and their salts

The polymer may optionally be cross-linked. Crosslinking monomers include, but are not limited to, ethylene glycoldiacrylatate, divinylbenzene, butadiene. The most preferred polymers are poly(acrylamide-co-diallyldimethylammonium chloride), poly(acrylamide-methacrylamidopropyltrimethyl ammonium chloride), poly(acrylamide-co-N,N-dimethyl aminoethyl methacrylate), poly(acrylamide-co-N,N-dimethyl aminoethyl methacrylate), poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride).

In order for the polymer deposition aids to be formulable and stable in the composition, the monomers are preferably incorporated in the polymer to form a copolymer, especially true when monomers having widely different reactivity ratios are used. In contrast to the commercial copolymers, the polymer deposition aids herein have a free monomer content less than 10%, preferably less than 5%, by weight of the monomers.

The polymer deposition aids can be random, block or grafted. They can be linear or branched. Such polymer deposition aids comprise from 1 to 60 mol percent, preferably from 1 to 40 mol percent, of the cationic monomer repeat units and from 98 to 40 mol percent, from 60 to 95 mol percent, of the nonionic monomer repeat units.

The polymer deposition aid preferably has a charge density of 0.1 to 6.0 milliequivalents/g (meq/g) of dry polymer, preferably 0.1 to 3 meq/g. This refers to the charge density of the polymer itself and is often different from the monomer feedstock. For example, for the copolymer of acrylamide and diallyldimethylammonium chloride with a monomer feed ratio of 70:30, the charge density of the feed monomers is 3.05 meq/g. However, if only 50% of diallyldimethylammonium is polymerized, the polymer charge density is only 1.6 meq/g. The polymer charge density is measured by dialyzing the polymer with a dialysis membrane or by NMR. For polymers with amine monomers, the charge density depends on the pH of the carrier. For these polymers, charge density is measured at a pH of 7.

The weight-average molecular weight of the polymer will generally be between 10,000 and 5,000,000, preferably from 100,000 to 2,00,000 and even more preferably from 200,000 and 1,500,000, as determined by size exclusion chromatography relative to polyethyleneoxide standards with RI detection. The mobile phase used is a solution of 20% methanol in 0.4M MEA, 0.1 M NaNO₃, 3% acetic acid on a Waters Linear Ultrandyrogel column, 2 in series. Columns and detectors are kept at 40° C. Flow is set to 0.5 mL/min.

Other useful polymer deposition aids include polyethylenimine and its derivatives. These are commercially available under the trade name Lupasol ex. BASF AG of Ludwigschaefen, Germany. Other suitable aids include Polyamidoamine-epichlorohydrin (PAE) Resins which are condensation products of polyalkylenepolyamine with polycarboxylc acid. The most common PAE resins are the condensation products of diethylenetriamine with adipic acid followed by a subsequent reaction with epichlorohydrin. They are available from Hercules Inc. of Wilmington Del. under the trade name Kymene or from BASF A.G. under the trade name Luresin. These polymers are described in Wet Strength resins and their applications edited by L. L. Chan, TAPPI Press (1994).

### External Structuring System:

The composition of the present invention preferably comprises from 0.05% to 2%, preferably from 0.1% to 1% by weight of an external structuring system. The external structuring system is preferably selected from the group consisting of:
i. non-polymeric crystalline, hydroxy-functional structurants and/or
ii. polymeric structurants
   As mentioned earlier, such external structuring systems are those which impart a sufficient yield stress or low shear viscosity to stabilize the fluid laundry detergent composition independently from, or extrinsic from, any structuring effect of the detersive surfactants of the composition. Preferably, they impart to the fluid laundry detergent composition a high shear viscosity at 20 sec-1 at 21° C. of from 1 to 1500 cps and a viscosity at low shear (0.05 sec-1 at 21° C.) of greater than 5000 cps. The viscosity is measured using an AR 550 rheometer from TA instruments using a plate steel spindle at 40 mm diameter and a gap size of 500 μm. The high shear viscosity at 20s-1 and low shear viscosity at 0.5-1 can be obtained from a logarithmic shear rate sweep from 0.1-1 to 25-1 in 3 minutes time at 21 C.

Preferred External Structurants Include:

### I. Non-Polymeric Crystalline, Hydroxy-Functional Structurant

In a preferred embodiment, the composition comprises a non-polymeric crystalline, hydroxyl functional structurant. Such non-polymeric crystalline, hydroxyl functional structurants generally comprise a cystallizable glyceride which can be pre-emulsified to aid dispersion into the final fluid laundry detergent composition. A non-limiting example of such a pre-emulsified external structuring system comprises: (a) crystallizable glyceride(s); (b) anionic surfactant; and (c) water and optionally, non-aminofunctional organic solvents. Each of these components is discussed in detail below.

a. Crystallizable Glyceride(s)

In some embodiments of the invention, the polymeric crystalline, hydroxy-functional structurant comprises a crystallizable glyceride, preferably hydrogenated castor oil or “HCO”. HCO as used herein most generally can be any hydrogenated castor oil or derivative thereof, provided that it is capable of crystallizing in the non-polymeric crystalline, hydroxy-functional structurant premix. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may, in some embodiments, be selected from: trihydroxystearin; dihydroxystearin; and mixtures thereof. The HCO may be processed in any suitable starting form, including, but not limited to those selected from solid, molten and mixtures thereof. HCO is typically present at a level of from 2% to 10%, from 3% to 8%, or from 4% to 6% by weight in the external structuring system. In some embodiments, the corresponding percentage of hydrogenated castor oil delivered into a finished laundry detergent product is below 1.0%, typically from 0.1% to 0.8%.

Useful HCO may have the following characteristics: a melting point of from 40° C. to 100° C., or from 65° C. to 95° C.; and/or Iodine value ranges of from 0 to 5, from 0 to 4, or from 0 to 2.6. The melting point of HCO can measured using either ASTM D3418 or ISO 11357; both tests utilize DSC: Differential Scanning calorimetry.

HCO of use in the present invention includes those that are commercially available. Non-limiting examples of commercially available HCO of use in the present invention include: THIXCIN® from Rheox, Inc. Further examples of useful HCO may be found in U.S. Pat. No. 5,340,390.

While the use of hydrogenated castor oil is preferred, any crystallisable glyceride can be used within the scope of the invention. Preferred crystallisable glyceride(s) have a melting point of from 40° C. to 100° C.

b. Anionic Surfactant

Anionic surfactant may be present in the non-polymeric crystalline, hydroxy-functional structurant system of use in the present invention and can be present at any suitable weight percentage of the total system. Without wishing to be bound by theory, it is believed that the anionic surfactant acts as an emulsifier of melts of HCO and other crystallizable glycerides. Any suitable anionic surfactant is of use in the non-polymeric crystalline, hydroxy-functional structurant. Non-limiting examples of suitable anionic surfactants of use herein include: Linear Alkyl Benzene Sulphonate (LAS), Alkyl Sulphates (AS), Alkyl Ethoxylated Sulphonates (AES), Laureth Sulfates and mixtures thereof. In some embodiments, the anionic surfactant may be present in the external structuring system at a level of from 5% to 50% by weight of the external structuring system. Note however, that when using more than 25% by weight of the structurant system, of an anionic surfactant, it is typically required to thin the surfactant using a non-aminofunctional organic solvent in addition to water.

The anionic surfactants are typically present in the form of their salts with alkanolamines or alkali metals such as sodium and potassium. Preferably, the anionic emulsifiers are neutralized with alkanolamines such as monoethanolamine or triethanolamine, and are fully soluble in the liquid phase of the external structuring system.

c. Water and Optionally, Non-Aminofunctional Organic Solvents

The non-polymeric crystalline, hydroxy-functional structurant generally comprises water, at levels of from 5% to 90%, preferably from 10% to 80%, more preferably from 30% to 70% by weight water. However organic non-aminofunctional organic solvents, typically consisting essentially of C, H and O (i.e., non-silicones and heteroatom-free) may also be present in the non-polymeric crystalline, hydroxy-functional structurant as solvents to help control or reduce viscosity, especially during processing.

### II. Polymeric Structurants

Fluid laundry detergent compositions of the present invention may comprise naturally derived and/or synthetic polymeric structurants.

Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof.

Examples of synthetic polymeric structurants of use in the present invention include: polycarboxylates, polyacrylates, hydrophobically modified ethoxylated urethanes, hydrophobically modified non-ionic polyols and mixtures thereof.

Preferably the polycarboxylate polymer is a polyacrylate, polymethacrylate or mixtures thereof. In another preferred embodiment, the polyacrylate is a copolymer of unsaturated mono- or di-carbonic acid and 1-30 C alkyl ester of the (meth) acrylic acid. Such copolymers are available from Noveon inc under the tradename Carbopol Aqua 30.

Multivalent Water-Soluble Organic Builder and/or Chelant:

The fluid laundry detergent compositions of the present invention comprise from 0.6% to 10%, preferably from 2 to 7% by weight of the multivalent water-soluble organic builder and/or chelants. Preferably, the multivalent water-soluble organic builder and/or chelants of the present invention are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene1,1diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as Tiron™ and mixtures thereof.

### Water:

The compact fluid laundry detergent compositions herein may be concentrated aqueous liquid or gel-form laundry detergent compositions. The water content of the fluid laundry detergent compositions of the present invention is from 1% to 45%, preferably from 10% to 40% by weight water.

### Organic, Non-Aminofunctional Solvent:

The fluid laundry detergent compositions of the present invention may comprise from 1% to 15% by weight of an organic, non-aminofunctional organic solvent. As used herein, “non-aminofunctional organic solvent” refers to any solvent which contains no amino functional groups, indeed contains no nitrogen. Non-aminofunctional solvent include, for example: C₁-C₅ alkanols such as methanol, ethanol and/or propanol and/or 1-ethoxypentanol; C₂-C₆ diols; C₃-C₈ alkylene glycols; C₃-C₈ alkylene glycol mono lower alkyl ethers; glycol dialkyl ether; lower molecular weight polyethylene glycols; C₃-C₉ triols such as glycerol; and mixtures thereof. More specifically non-aminofunctional solvent are liquids at ambient temperature and pressure (i.e. 21° C. and 1 atmosphere), and comprise carbon, hydrogen and oxygen.

Organic non-aminofunctional organic solvents may be present when preparing the external structuring system premix, or in the final fluid laundry detergent composition. Preferred organic non-aminofunctional solvents include monohydric alcohols, dihydric alcohols, polyhydric alcohols, glycerol, glycols, polyalkylene glycols such as polyethylene glycol, and mixtures thereof. Highly preferred are mixtures of solvents, especially mixtures of lower aliphatic alcohols such as ethanol, propanol, butanol, isopropanol, and/or diols such as 1,2-propanediol or 1,3-propanediol; or mixtures thereof with glycerol. Suitable alcohols especially include a C1-C4 alcohol. Preferred is 1,2-propanediol or ethanol and mixtures thereof, or propanediol and mixtures thereof with diethylene glycol where the mixture contains no methanol or ethanol. Thus embodiments of fluid detergent laundry compositions of the present invention may include embodiments in which propanediols are used but methanol and ethanol are not used.

### Laundering Adjuncts:

The fluid laundry detergent compositions of the present invention may also include conventional laundry detergent ingredients selected from the group consisting of: additional surfactants, enzymes, enzymes stabilizers, optical brighteners, particulate material, hydrotropes, perfume and other odour control agents, soil suspending polymers and/or soil release polymers, suds suppressors, fabric care benefits, pH adjusting agents, dye transfer inhibiting agents, preservatives, non-fabric substantive dyes and mixtures thereof. Some of the optional ingredients which can be used are described in greater detail as follows:

a. Additional Surfactants

The fluid laundry detergent compositions of the present invention preferably comprise additional surfactant selected from the group consisting: anionic, cationic, nonionic, amphoteric and/or zwitterionic surfactants and mixtures thereof.

Cationic surfactants: Cationic surfactants of use in the present invention can be water-soluble, water-dispersable or water-insoluble. Such cationic surfactants have at least one quaternized nitrogen and at least one long-chain hydrocarbyl group. Compounds comprising two, three or even four long-chain hydrocarbyl groups are also included. Examples include alkyltrimethylammonium salts, such as C12 alkyltrimethylammonium chloride, or their hydroxyalkyl substituted analogs. Compositions known in the art may comprise, for example, 1% or more of cationic surfactants, such as C12 alkyltrimethylammonium chloride. Such cationic surfactants are organic cationically charged moieties. Without intending to be limited by theory, they are capable of ion-pairing with the anionic surfactants in the composition, and interfering with the deposition aid. In preferred embodiments of the present invention, the use of such organic cationically charged moieties, especially cationic surfactants, is avoided.

Nonionic surfactants: Suitable nonionic surfactants include, but are not limited to C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic*-BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

Alkylpolysaccharides such as disclosed in U.S. Pat. No. 4,565,647 Llenado are also useful nonionic surfactants in the compositions of the invention.

Also suitable are alkyl polyglucoside surfactants.

In some embodiments, nonionic surfactants of use include those of the formula R1(OC2H4)nOH, wherein R1 is a C10 C16 alkyl group or a C8 C12 alkyl phenyl group, and n is from 3 to about 80. In some embodiments, the nonionic surfactants may be condensation products of C12 C15 alcohols with from about 5 to about 20 moles of ethylene oxide per mole of alcohol, e.g., C12 C13 alcohol condensed with about 6.5 moles of ethylene oxide per mole of alcohol

Additional suitable nonionic surfactants include polyhydroxy fatty acid amides of the formula:

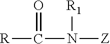

wherein R is a C9-17 alkyl or alkenyl, R1 is a methyl group and Z is glycidyl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798.

Amphoteric and/or Zwitterionic Surfactants:

Suitable amphoteric or zwitterionic detersive surfactants for use in the fluid laundry detergent compositions of the present invention include those which are known for use in hair care or other personal care cleansing. Non-limiting examples of suitable zwitterionic or amphoteric surfactants are described in U.S. Pat. Nos. 5,104,646 (Bolich Jr. et al.), 5,106,609 (Bolich Jr. et al.).

Amphoteric detersive surfactants suitable for use in the composition include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulfonate, sulfate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

Zwitterionic detersive surfactants suitable for use in the compositions are well known in the art, and include those surfactants broadly described as derivatives of aliphatic quaternary ammonium, phosphonium, and sulfonium compounds, in which the aliphatic radicals can be straight or branched chain, and wherein one of the aliphatic substituents contains from 8 to 18 carbon atoms and one contains an anionic group such as carboxy, sulfonate, sulfate, phosphate or phosphonate. Zwitterionics such as betaines are suitable for this invention.

Furthermore, amine oxide surfactants having the formula: R(EO)ₓ(PO)_{y}(BO)_{z}N(O)(CH₂R′)₂.qH₂O (I) are also useful in compositions of the present invention. R is a relatively long-chain hydrocarbyl moiety which can be saturated or unsaturated, linear or branched, and can contain from 8 to 20, preferably from 10 to 16 carbon atoms, and is more preferably C12-C16 primary alkyl. R′ is a short-chain moiety preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of other anionic, zwitterionic, amphoteric or optional additional surfactants suitable for use in the compositions are described in McCutcheon's, Emulsifiers and Detergents, 1989 Annual, published by M. C. Publishing Co., and U.S. Pat. Nos. 3,929,678, 2,658,072; 2,438,091; 2,528,378.

b. Enzymes

The fluid laundry detergent compositions of the present invention may comprise one or more detersive enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, cutinase and/or cellulase in conjunction with amylase. Detersive enzymes are described in greater detail in U.S. Pat. No. 6,579,839.

c. Enzyme Stabilizers

Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

d. Optical Brighteners

Also known as fluorescent whitenening agents for textiles are useful laundering adjuncts in fluid laundry detergent compositions of the present invention. Suitable use levels are from 0.001% to 1% by weight of the fluid laundry detergent composition. Brighteners are for example disclosed in EP 686691B and include hydrophobic as well as hydrophilic types. Brightener 49 is preferred for use herein.

e. Hueing Dyes

Hueing dyes, shading dyes or fabric shading or hueing agents are useful laundering adjuncts in fluid laundry detergent compositions. The history of these materials in laundering is a long one, originating with the use of “laundry blueing agents” many years ago. More recent developments include the use of sulfonated phthalocyanine dyes having a Zinc or aluminium central atom; and still more recently a great variety of other blue and/or violet dyes have been used for their hueing or shading effects. See for example WO 2009/087524 A1, WO2009/087034A1 and references therein. The fluid laundry detergent compositions herein typically comprise from 0.00003 wt % to 0.1 wt %, from 0.00008 wt % to 0.05 wt %, or even from 0.0001 wt % to 0.04 wt %, fabric hueing agent.

f. Particulate Material

The fluid laundry detergent composition may include particulate material such as clays, suds suppressors, encapsulated sensitive ingredients, e.g., perfumes, bleaches and enzymes in encapsulated form; or aesthetic adjuncts such as pearlescent agents, pigment particles, mica or the like. Suitable use levels are from 0.0001% to 5%, or from 0.1% to 1% by weight of the fluid laundry detergent composition.

g. Perfume and Odour Control Agents

In one embodiment, the fluid laundry detergent composition comprises a perfume. If present, perfume is typical incorporated in the present compositions at a level from 0.001 to 10%, preferably from 0.01% to 5%, more preferably from 0.1% to 3% by weight.

In one embodiment, the perfume of the fluid laundry detergent composition of the present invention comprises one or more enduring perfume ingredient that has a boiling point of 250° C. or higher and a ClogP of 3.0 or higher, more preferably at a level of at least 25%, by weight of the perfume. Suitable perfumes, perfume ingredients, and perfume carriers are described in U.S. Pat. No. 5,500,138; and US 20020035053 A1.

In another embodiment, the perfume comprises a perfume microcapsule and/or a perfume nanocapsule. Suitable perfume microcapsules and perfume nanocapsules include those described in the following references: US 2003215417 A1; US 2003216488 A1; US 2003158344 A1; US 2003165692 A1; US 2004071742 A1; US 2004071746 A1; US 2004072719 A1; US 2004072720 A1; EP 1393706 A1; US 2003203829 A1; US 2003195133 A1; US 2004087477 A1; US 20040106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32713; U.S. Pat. No. 4,234,627.

In yet another embodiment, the fluid laundry detergent composition comprises odor control agents such as described in U.S. Pat. No. 5,942,217: “Uncomplexed cyclodextrin compositions for odor control”, granted Aug. 24, 1999. Other agents suitable odor control agents include those described in: U.S. Pat. No. 5,968,404, U.S. Pat. No. 5,955,093; U.S. Pat. No. 6,106,738; U.S. Pat. No. 5,942,217; and U.S. Pat. No. 6,033,679.

h. Hydrotropes

The fluid laundry detergent composition optionally comprises a hydrotrope in an effective amount, i.e. from 0% to 15%, or 1% to 10%, or 3% to 6%, so that the fluid laundry detergent compositions are compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

i. Cleaning Polymers

The detergent compositions herein may optionally contain cleaning polymers that provide for broad-range soil cleaning of surfaces and fabrics and/or suspension of the soils. Any suitable cleaning polymer may be of use. Useful cleaning polymers are described in the co-pending patent application published as USPN 2009/0124528A1. Non-limiting examples of useful categories of cleaning polymers include: amphiphilic alkoxylated grease cleaning polymers; clay soil cleaning polymers; soil release polyers; and soil suspending polymers.

### Unit Dose Detergent:

In some embodiments of the present invention, the fluid laundry detergent compositions are enclosed in a water soluble film material, such as a polyvinyl alcohol, to form a unit dose pouch. In some embodiments, the unit dose pouch comprises a single or multi-compartment pouch where the fluid laundry detergent composition of the present invention can be used in conjunction with any other conventional powder or liquid detergent composition. Examples of suitable pouches and water soluble film materials are provided in U.S. Pat. Nos. 6,881,713, 6,815,410, and 7,125,828.

Preferred polymers, copolymers or derivatives thereof suitable for use as pouch material are selected from the group: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

### Method of Treating Fabrics and Uses of Fluid Laundry Detergent Compositions of the Present Invention:

A method of treating a substrate by contacting a substrate with a fluid laundry detergent composition of the present invention is incorporated in the present invention. As used herein, “fluid laundry detergent compositions” include fabric treatment compositions and liquid laundry detergent compositions for handwash, machine wash and other purposes including fabric care additive compositions and compositions suitable for use in the soaking and/or pretreatment of stained fabrics.

If used as a liquid fabric care product, e.g., a fabric softening product, the compositions can be used to form aqueous fabric treatment baths containing from 500 ppm to 5.000 ppm of the fabric treatment compositions. If used as a laundry detergent product, the compositions can be used to form aqueous washing liquor containing from 5.000 ppm to 20.000 ppm of the fluid laundry detergent composition.

### Method of Evaluating the Phase Stability of Fluid Laundry Detergent Compositions:

The phase stability of the fluid laundry detergent compositions is evaluated by placing 300 ml of the composition in a glass jar for up to a time period of 21 days at 21° C. They are stable to phase splits if, within said time period, (i) they are free from splitting into two or more layers or, (ii) said composition splits into layers, a major layer comprising at least 90%, preferably 95%, by weight of the composition is present.

### EXAMPLES

Examples 1 to 3 are non-limiting embodiments illustrative of the present invention. Percentages are by weight unless otherwise specified. Example 4 is a comparative example of a composition that is not phase stable as defined in the test method disclosed in the application.

TABLE 1

| | Liquid Detergent Compositions | | | |
|---|---|---|---|---|
| Ingredient (% by weight) | Example 1 | Example2 | Example 3 | Example 4 |
| Linear Alkylbenzene sulfonic acid | 9 | 12 | 10 | 9 |
| C12-14 alkyl ethoxy 3 sulfate MEA salt | 9 | 9 | 8 | 9 |
| C12-14 alkyl 7-ethoxylate | 8 | 6 | 7 | 8 |
| C12-18 Fatty acid | 8 | 8 | 8 | 8 |
| Citric acid | 3 | 3 | 3 | 3 |
| Ethoxysulfated Hexamethylene Diamine | — | 2.1 | — | — |
| Dimethyl Quat | | | | |
| Soil Suspending Alkoxylated | 2.1 | — | — | 2.1 |
| Polyalkylenimine Polymer¹ | | | | |
| Hydroxyethane diphosphonic acid | 1.5 | 1.5 | 1.5 | 1.5 |
| PAM-MAPTAC copolymer² | 0.47 | 0.40 | 0.50 | 0.47 |
| Fluorescent Whitening Agent | 0.2 | 0.2 | 0.2 | 0.2 |
| 1,2 Propanediol | 7 | 7 | 7 | 7 |
| Diethyleneglycol | 4 | 4 | 4 | 4 |
| Hydrogenated castor oil (HCO) | 0.75 (introduced via external structurant | | | — |
| | system premix) | | | |
| Monoethanolamine (MEA) | 8.5-10 (up to pH 8.0) | | | |
| Perfume | 1.7 | 1.7 | 1.7 | 1.7 |
| Enzymes | 1.7 | 2.0 | 2.0 | 1.7 |
| Water and minors (antifoam, dyes, etc.) | Up to 100% | | | |
| | Phase stable | Phase stable | Phase stable | Not |
| | | | | phase stable |

¹600 g/mol weight average molecular weight polyethylenimine substituted with 20 ethoxylate groups per —NH.
²PAM-MAPTAC copolymer: random copolymer of 88 mol % polyacrylamide, 12 mol % MAPTAC.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fluid laundry detergent composition comprising:
a) an anionic surfactant,
b) a polymer deposition aid,
c) an external structuring system,
d) from about 0.6% to about 10% by weight of the fluid laundry detergent composition of a multivalent water-soluble organic builder and/or chelant, and
e) from about 1% to about 45% by weight of water.

2. A fluid laundry detergent composition according to claim 1, comprising from about 0.1% to about 7% of the polymer deposition aid.

3. A fluid laundry detergent composition according to claim 2, comprising from about 0.2% to about 3% by weight of the polymer deposition aid.

4. A fluid laundry detergent composition according to claim 1, wherein the polymer deposition aid comprises a cationic polysaccharide and/or a copolymer, wherein the copolymer comprises:
a) a cationic monomer selected from a group consisting N,N-dialkylaminoalkyl methacrylate, N,N-dialkylaminoalkyl acrylate, N,N-dialkylaminoalkyl acrylamide, N,N-dialkylaminoalkylmethacrylamide, their quaternized derivatives, vinylamine and its derivatives, allylamine and its derivatives, vinyl imidazole, quaternized vinyl imidazole and diallyl dialkyl ammonium chloride and mixtures thereof,
b) a second monomer selected from a group consisting of: acrylamide (AM), N,N-dialkyl acrylamide, methacrylamide, N,N-dialkylmethacrylamide, C1-C12 alkyl acrylate, C1-C12 hydroxyalkyl acrylate, C1-C12 hydroxyetheralkyl acrylate, C1-C12 alkyl methacrylate, C1-C12 hydroxyalkyl methacrylate, vinyl acetate, vinyl alcohol, vinyl formamide, vinyl acetamide, vinyl alkyl ether, vinyl butyrate and derivatives and mixtures thereof.

5. A fluid laundry detergent composition according to claim 1, comprising from about 0.05% to about 2% of the external structuring system.

6. A fluid laundry detergent composition according to claim 5, comprising from about 0.1% to about 1% by weight of the external structuring system.

7. A fluid laundry detergent composition according to claim 1, wherein the external structuring system is selected from the group consisting of non-polymeric crystalline, hydroxy-functional structurants and/or polymeric structurants.

8. A fluid laundry detergent composition according to claim 7, wherein the external structuring system consists of a non-polymeric crystalline, hydroxy-functional structurants, comprising a crystallizable glyceride.

9. A fluid laundry detergent composition according to claim 8, wherein the crystallizable glyceride is a hydrogenated castor oil.

10. A fluid laundry detergent composition according to claim 7, wherein the external structuring system consists of a polymeric structurant selected from the group consisting of: microfibrillated cellulose, hydroxyethyl cellulose, hydrophobically modified hydroxyethyl cellulose, carboxymethyl cellulose, polysaccharide derivatives, polycarboxylates, polyacrylates, hydrophobically modified ethoxylated urethanes, hydrophobically modified non-ionic polyols and mixtures thereof.

11. A fluid laundry detergent composition according to claim 1, comprising from about 2 to about 7% by weight of the multivalent water-soluble organic builder and/or chelant.

12. A fluid laundry detergent composition according claim 1, wherein the multivalent water-soluble organic builder and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene1,1diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates and mixtures thereof.

13. A fluid laundry detergent composition according to claim 1, further comprising from about 1% to about 15% by weight of a non-aminofunctional organic solvent.

14. A fluid laundry detergent composition according to claim 1, comprising from about 10% to about 40% by weight water.

15. A fluid laundry detergent composition according to claim 1, wherein said fluid laundry detergent composition is enclosed in a water-soluble film.

16. A method for treating a substrate by contacting the substrate with a fluid laundry detergent composition according to claim 1.
